(19) United States
(12) Patent Application Publication
(10) Pub. No.: US 2015/0217603 A1
(43) Pub. Date: Aug. 6, 2015

(54) TIRE CORD FABRIC

(71) Applicant: KORDSA GLOBAL ENDUSTRIYEL IPLIK VE KORD BEZI SANAYI VE TICARET ANONIM SIRKETI, Izmit (TR)

(72) Inventors: Sadettin Fidan, Garbsen (DE); Kürsat Aksoy, Izmit (TR); Dogan Sevim, Izmit (TR)

(73) Assignee: KORDSA GLOBAL ENDUSTRIYEL IPLIK VE KORD BEZI SANAYI VE TICARET ANONIM SIRKETI, Izmit (TR)

(21) Appl. No.: 14/425,322

(22) PCT Filed: Sep. 18, 2013
(86) PCT No.: PCT/IB2013/058636

§ 371 Date: Mar. 3, 2015

(30) Foreign Application Priority Data
Oct. 18, 2012 (TR) 2012/12032

(51) Int. Cl. B60C 9/04; B60C 13/02; D03D 15/00; D03D 3/08; D03D 15/08; B60C 9/00; B60C 19/00

(52) U.S. Cl. CPC B60C 9/04; B60C 9/005; B60C 13/02; B60C 19/002; D03D 3/08; D03D 15/08; D03D 15/0027; B60C 2009/0483; B60C 2009/0475; B60C 2009/0458; B60C 2009/0035; D10B 2201/22; D10B 2331/04; D10B 2331/02; D10B 2505/022

(57) ABSTRACT

A tire cord fabric (1) which comprises alternate cords (2,3) with different tensile extensibilities is used as carcass reinforcement in radial pneumatic tires. The tire cord fabric (1) is formed by cords (2, 3) having different tensile extensibilities and is used as reinforcement in radial pneumatic tires to provide a sidewall area with an ondulated carcass structure.

### FIELD OF THE INVENTION

The present invention relates to a tire cord fabric which comprises alternate cords with different tensile extensibilities and is used as carcass reinforcement in radial pneumatic tires.

### BACKGROUND OF THE INVENTION

In tire technology, cornering stiffness and other performance values of the tire are maintained in the desired ranges, whereas the rolling resistance and reducing the weight is highly demanded.

Increasing the carcass cord diameter in order to increase the cornering stiffness of the tire also means increasing the rubber gauge which has negative effect on weight and rolling resistance. On the other hand, increase in end count (epdm, ends per decimeter) with or without reducing the cord gauge causes decrease in fatigue resistance of the tire since it increases the strain energy density between adjacent cords and crack formation potential.

U.S. patent document no U.S. Pat. No. 3,500,888, an application known in the state of the art, discloses using thermal shrinkable cords together with the cords that do not shrink as carcass reinforcement in pneumatic radial and diagonal tires. According to the claims of the said patent document, in vulcanization process during forming two separate layers from one carcass layer, thermally shrinking cords move inwards. An extra rubber layer, in which the shrinkage penetration takes place, is included in the structure in order to provide enough matrix for the said separated cords.

According to the U.S. Pat. No. 3,500,888 patent document, increase in bending resistance in tire sidewall results from double layer formation, however an extra rubber layer is added bead to bead in the tire in order to realize this aim. This situation increases the rubber amount and weight of the tire, and creates negative effect on, the rolling resistance. Furthermore, in the document, the reduced elastic modules (high elongation) of the cords thermally shrunk during vulcanization process and the effect of the inflation pressure is not disclosed. Thermally shrunk cords (for example nylon or PET) have higher elongation property than the cords that do not shrink (for example rayon), and they can elongate much more after vulcanization process because of the relaxation effect of the thermal shrinkage. After inflation, cords with low elastic modulus elongate much more than the cords with high elastic modulus, and the double layer formation (separation cords from each other) is reversed or loses its effect. In the document, bead slippage of carcass cords is not disclosed. Furthermore, if a significantly stiff/viscous rubber is not used, the cords may penetrate the rubber and become visible in the inner liner during vulcanization process because of the thermal shrinkforce.

Any temperature variation that can occur during vulcanization process cause variations in shrinkage levels of cords in different carcass positions and thus lack of homogenous distribution in the tire.

### SUMMARY OF THE INVENTION

The objective of the present invention is to provide a tire cord fabric which is formed with cords with different tensile extensibilities and used as a reinforcement material in radial pneumatic tires.

Another objective of the present invention is to provide a tire cord fabric which enables strengthening the shoulder area in radial pneumatic tires by providing an undulated carcass structure in the said area.

### BRIEF DESCRIPTION OF THE DRAWINGS

“A tire cord fabric” developed to fulfill the objectives of the present invention is illustrated in the accompanying figures, in which:

FIG. 1 is the cross section view of the tire cord fabric in the previous art.

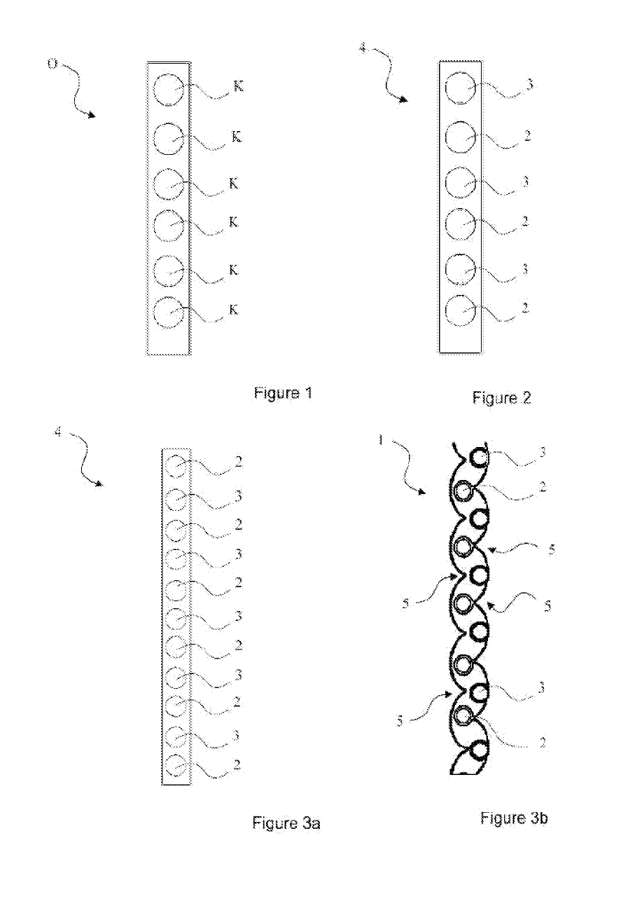

FIG. 2 is the cross section view of the inventive tire cord fabric.

FIG. 3 (a) is the cross section view of the tire cord fabric (carcass) before vulcanization process and/or inflation.
(b) is the cross section view of the tire cord fabric (carcass) after vulcanization process and/or inflation.

FIG. 4 (a) is the cross section view of the tire cord fabric (carcass) before vulcanization process and/or inflation.
(b) is the cross section view of the tire cord fabric (carcass) after vulcanization process and/or inflation.

FIG. 5 (a) is the side schematic view of the turn up of the tire cord fabric (carcass) before vulcanization process.
(b) is the side schematic view of the turn up of the tire cord fabric (carcass) after vulcanization process.

The components shown in the figures are each given reference numerals as follows:

1. Tire cord fabric

2. Cord with high elongation at specified load (EASL)

3. Cord with low elongation at specified load (EASL)

4. Cord fabric comprising different elongation properties alternatingly (before vulcanization process)

5. Channel

O. Tire cord fabric in the previous technique

K. Conventional cord

### DETAILED DESCRIPTION OF THE INVENTION

The inventive tire cord fabric (1) comprises
cords (2) with high elongation coefficient which have high elongation coefficient, stated as value of elongation at specific load (EASL), and thus the length of which changes much more than the cords at both sides during vulcanization and/or in case pressurized air is applied (inflation),
cords (3) with low elongation coefficient which have low elongation coefficient, stated as value of elongation at specific load (EASL), and thus the length of which changes less than the cords at both sides during vulcanization and/or in case pressurized air is applied (inflation),
cord fabric (4) which comprises cords formed by aligning the cords with high and low elongation at specific load (2, 3) and used as warp cords, dipped with RFL and having different elongation properties alternatingly,
channels (5) which are formed between the said cords (2, 3) and parallel to the said cords (2, 3) because of the difference between the elongations at specific load (EASL) of the cords (2, 3) in the structure of cord fabric (4) that comprises cords having alternatingly different elongation properties and present as carcass reinforcement within the carcass after vulcanization process.

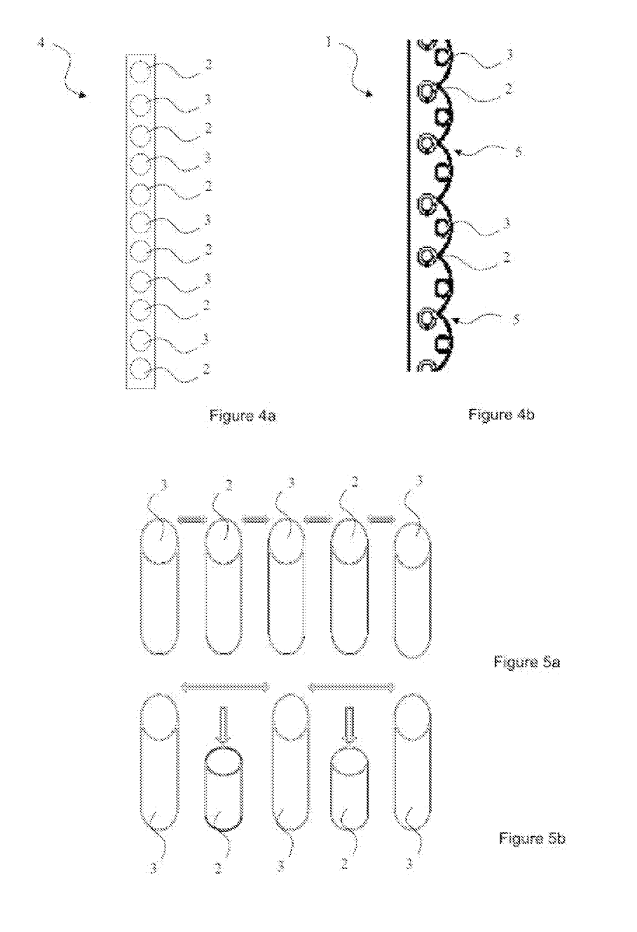

The said invention relates to the structure of the carcass reinforcement material which has parallel cords (2, 3) aligned alternatingly, having different modulus or elongations at specific load. (FIG. 2)

The alternating carcass cords with different elongations (2, 3) in the tire cord fabric (1) form an undulated or zig-zag geometry in radial section by means of the channels (5) formed between the cords (2, 3) after vulcanization process and inflation (FIGS. 3 and 4). Such carcass geometry in the tire increases the lateral stiffness and improves the cornering stiffness and steering stability of the tire. Ondulation is mostly preferred in the sidewall area least preferred in underbelt and tire sidewall.

In another embodiment of the invention, at vulcanization process (curing) temperature, the difference in cord slippage of the alternating carcass cords (2, 3) with high and low (or zero) thermal shrinkforce around the bead is shown (FIG. 5a, 5b).

Since the distance between the ends of the cords (2, 3) increases, the fatigue resistance (crack formation and distribution potential resistance) in turn up area will increase. By means of the micro channels (5) which the undulated tire cord fabric (1) has, the noise generated within the tire will be partially absorbed.

The parameters effecting the cord extensibility in tire under constant pressure are material (yam type), material composition in the cord (hybrid composition), linear density (dtex) and helix angle of the cord. The cord parameters effecting the carcass slippage around the bead are thermal shrinkage of the cord under vulcanization process temperature and shrinkforce.

In the preferred embodiment of the invention, as high and low EASL cords (2, 3), at least one material selected from the group comprising rayon, PET, PEN and aramide which have different twist levels but similar dtex is used. High EASL cord (2) has at least %10 higher twists (tpm, turns per meter) than the low EASL cord (3).

In one embodiment of the invention, rayon is used as low EASL (3), and at least one of hybrid cords such as rayon/nylon, rayon/PET or PET/nylon is used as high EASL cord (2).

In another embodiment of the invention, PET fibers are used as low EASL (3), and at least one of hybrid cords such as rayon/nylon, rayon/PET or PET/nylon is used as high EASL cord (2).

In another embodiment of the invention, PEN is used as low EASL (3), and at least one of hybrid cords such as rayon/nylon, PEN/PET or PEN/nylon is used as high EASL cord (2).

In another embodiment of the invention, aramide fibers are used as low EASL (3), and at least one of hybrid cords such as aramide/nylon, aramide/PET is used as high EASL cord (2).

The nominal dtex value of the cords (2, 3) used in the inventive tire cord fabric (1) can vary between 800 and 6000 dtex.

The twist levels of the cords (2, 3) used in the inventive tire cord fabric (1) can vary between 150 and 700 tpm (turns per meter).

Within the framework of these basic concepts, it is possible to develop a wide variety of embodiments of the inventive tire cord fabric (1). The invention cannot be limited to the examples described herein and it is essentially as defined in the claims.

1. A tire cord fabric which is used as carcass reinforcement material in order to increase the lateral stiffness of a pneumatic tire, comprising,
plurality of cords with high elongation which have high elongation coefficient, stated as value of elongation at specific load (EASL), and thus the length of which changes much more than the cords at both sides during vulcanization and/or in case pressurized air is applied (inflation);
a plurality of cords with low elongation which have low elongation coefficient, stated as value of elongation at specific load (EASL), and thus the length of which changes less than the cords at both sides during vulcanization and/or in case pressurized air is applied (inflation);
at least one cord fabric which comprises cords formed by aligning the cords with high and low elongation at specific load and used as warp cords, dipped with RFL and having different elongation properties alternatingly;
a plurality of channels which are formed between the said cords and parallel to the said cords because of the difference between the elongations at specific load (EASL) of the cords in the structure of cord fabric that comprises cords having alternatingly different elongation properties and presents as carcass reinforcement within the carcass after vulcanization process.

2. The tire cord fabric according to claim 1, wherein, as cords with high and low elongation coefficient at least one material selected from the group comprising rayon, PET, PEN, aramide with different twist levels but similar dtex is used.

3. The tire cord fabric according to claim 2, wherein the twist level of the cord with high elongation is at least %10 more than the cord with low elongation.

4. The tire cord fabric according to claim 3, wherein rayon is used as low EASL, cord, and at least one material which is one of rayon/nylon, rayon/PET or PET/nylon hybrid cords is used as high EASE cord.

5. The tire cord fabric according to claim 3, wherein PET is used as low EASL cord, and at least one material which is one of rayon/nylon, nylon/PET hybrid cords is used as high EASL cord.

6. The tire cord fabric according to claim 3, wherein PEN is used as low EASL cord, and at least one material which is one of rayon/nylon, PEN/PET or PET/nylon hybrid cords is used as high EASL cord.

7. The tire cord fabric (1) according to claim 3, wherein aramide is used as low EASL cord, and at least one material which is one of aramide/nylon, aramide/PET hybrid cords is used as high EASL cord.

8. The tire cord fabric according to claim 1, wherein the nominal dtex value of the cords change between 800 and 6000 dtex.

9. The tire cord fabric according to claim 1, wherein the twist levels of the cords change between 150 and 700 tpm (turns per meter).

10. The tire cord fabric according to claim 1, wherein the channels in the sidewall area absorb the noise in the tire significantly.
